(19) United States
(12) Patent Application Publication
(10) Pub. No.: US 2016/0122482 A1
(43) Pub. Date: May 5, 2016

(54) FIBER-REINFORCED RESIN SHEET AND PROCESS FOR PRODUCING SAME

(71) Applicant: Asahi Glass Company, Limited, Chiyoda-ku (JP)

(72) Inventors: Yoshiaki HIGUCHI, Chiyoda-ku (JP); Shun SAITO, Chiyoda-ku (JP); Kiyoshi KASAHARA, Chiyoda-ku (JP)

(73) Assignee: Asahi Glass Company, Limited, Chiyoda-ku (JP)

(21) Appl. No.: 14/992,125

(22) Filed: Jan. 11, 2016

Related U.S. Application Data
(63) Continuation of application No. PCT/JP2014/069246, filed on Jul. 18, 2014.

(30) Foreign Application Priority Data
Jul. 26, 2013 (JP) 2013-155801
Dec. 25, 2013 (JP) 2013-267914

(51) Int. Cl. C08J 5/04; B32B 27/08; B32B 27/30; B32B 27/32

(52) U.S. Cl. CPC C08J 5/043; B32B 27/322; B32B 27/08; B32B 27/304; B32B 27/308; C08J 2327/18; C08J 2327/14; C08J 2329/10; C08J 2327/16; C08J 2433/12; B32B 2262/101; B32B 2250/24; B32B 2250/02; B32B 2307/412

(57) ABSTRACT

To provide a fiber-reinforced resin sheet having flame proofing property and being excellent in weather resistance and transparency, and to provide a production process thereof.

A fiber-reinforced resin sheet 10, comprising a matrix resin 12 containing at least 50 mass % of a fluorinated resin; and a glass fiber cloth 14 having an open area ratio of at most 20%, embedded in the matrix resin 12, said fiber-reinforced resin sheet having at least 70% of a total light transmittance.

### TECHNICAL FIELD

The present invention relates to a fiber-reinforced resin sheet comprising a matrix resin and a glass fiber cloth embedded in the matrix resin, a process for producing the same, and a laminate comprising a layer of the fiber-reinforced resin sheet and a layer of a fluorinated resin.

### BACKGROUND ART

A fiber-reinforced resin sheet is used as a membrane material (such as a roof material or an exterior wall material) for membrane structure buildings (such as sports facilities, large-scale greenhouses and atria). The fiber-reinforced resin sheet as a membrane material for membrane structure buildings is required to have e.g. flame proofing property, weather resistance and transparency.

As a fiber-reinforced resin sheet having flame proofing property, for example, the following one has been proposed.

(1) A nonflammable sheet material having a resin layer made of a vinyl chloride resin (hereinafter, referred to as “PVC”) provided on at least one surface of a glass fiber woven fabric (Patent Document 1).

As a fiber-reinforced resin sheet using a fluorinated resin having good weather resistance, for example, the following ones have been proposed.

(2) A fluororesin laminate obtained by impregnating a glass fiber cloth with a dispersion of polytetrafluoroethylene (hereinafter, referred to as “PTFE”) and heat-sintering the dispersion of PTFE (Patent Document 2).

(3) A laminate sheet obtained by sandwiching a glass fiber cloth with a pair of ethylene/tetrafluoroethylene copolymer (hereinafter, referred to as “ETFE”) films, and heating them to be laminated (Patent Document 3).

### PRIOR ART DOCUMENTS

### Patent Documents

Patent Document 1: Japanese Patent No. 4,186,488

Patent Document 2: Japanese Patent No. 2,577,389

Patent Document 3: WO2008/105298

### DISCLOSURE OF INVENTION

### Technical Problem

However, the flame-retardant sheet material of the above (1) is insufficient in weather resistance since the resin layer is made of PVC.

The fluororesin laminate of the above (2) has a plurality of air gaps between PTFE particles since a matrix resin is obtained by heat-sintering the dispersion of PTFE. Therefore, due to the difference in refractive indices between PTFE or the glass fiber and air of air gaps, light is scattered, whereby transparency deteriorates.

In the case of the laminate sheet of the above (3) where fluorinated resin films and a glass fiber cloth are simply laminated, a fluorinated resin is less likely to permeate into glass fibers of the glass fiber cloth, and a plurality of air gaps remain in glass fibers. Therefore, due to the difference in refractive indices between the glass fiber or the fluorinated resin and air of air gaps, light is scattered, whereby transparency deteriorates. Accordingly, in the laminate sheet of the above (3), the glass fiber cloth is made to have an open area ratio of at least 30% in order to improve the transparency. However, the glass fiber cloth having such a high open ratio, may easily be burned out by fire in e.g. an external fire exposure test, and the flame proofing property is thus insufficient.

It is an object of the present invention to provide a fiber-reinforced resin sheet having flame proofing property and being excellent in weather resistance and transparency, and to provide a production process thereof.

### Solution to Problem

The present invention provides a fiber-reinforced resin sheet, a production process thereof, and a laminate, having the following constructions [1] to [15].

[1] A fiber-reinforced resin sheet, comprising:

a matrix resin containing at least 50 mass % of a fluorinated resin; and

a glass fiber cloth having an open area ratio of at most 20%, embedded in the matrix resin,

said fiber-reinforced resin sheet having a total light transmittance of at least 70%.

[2] The fiber-reinforced resin sheet according to [1], wherein the total light transmittance is at least 80%.
[3] The fiber-reinforced resin sheet according to [1] or [2], wherein the matrix resin consists of the fluorinated resin.
[4] The fiber-reinforced resin sheet according to any one of [1] to [3], wherein the fluorinated resin is a cured product of a curable fluorinated copolymer having units derived from a fluoroolefin and units derived from a monomer other than the fluoroolefin, said monomer being copolymerizable with the fluoroolefin.
[5] The fiber-reinforced resin sheet according to [4], wherein the units derived from a monomer other than the fluoroolefin are units derived from a monomer having a hydroxy group.
[6] The fiber-reinforced resin sheet according to any one of [1] to [3], wherein the matrix resin contains a solvent-soluble fluorinated resin.
[7] The fiber-reinforced resin sheet according to [6], wherein the matrix resin is a blend resin containing polyvinylidene fluoride and polymethyl methacrylate.
[8] The fiber-reinforced resin sheet according to any one of [1] to [7], wherein the matrix resin further contains an ultraviolet absorber.
[9] The fiber-reinforced resin sheet according to any one of [1] to [8], which is a membrane material for membrane structure buildings.
[10] A process for producing the fiber-reinforced resin sheet as defined in [4] or [5], which comprises:

impregnating the glass fiber cloth with a solution having a curable resin material containing the curable fluorinated copolymer dissolved in a solvent,

removing the solvent, and then

curing the curable resin material to form the matrix resin.

[11] A process for producing the fiber-reinforced resin sheet as defined in [6] or [7], which comprises:

impregnating the glass fiber cloth with a solution having the matrix resin dissolved in a solvent, and then

removing the solvent.

[12] A laminate, comprising:

a layer of the fiber-reinforced resin sheet as defined in any one of [1] to [8]; and

a layer of a second fluorinated resin provided on one side or each side of the fiber-reinforced resin sheet,

said laminate having a total light transmittance of at least 70%.

[13] The laminate according to [12], wherein the layer of a second fluorinated resin is a layer formed from a film or sheet of the second fluorinated resin.
[14] The laminate according to [12] or [13], wherein the layer of a second fluorinated resin contains an ultraviolet absorber.
[15] The laminate according to any one of [12] to [14], which is a membrane material for membrane structure buildings.

### Advantageous Effects of Invention

The fiber-reinforced resin sheet of the present invention and the laminate of the present invention have flame proofing property and are excellent in weather resistance and transparency.

According to the process for producing a fiber-reinforced resin sheet of the present invention, it is possible to produce a fiber-reinforced resin sheet having flame proofing property and being excellent in weather resistance and transparency. According to e.g. a method of laminating a film or sheet of a second fluorinated resin on the fiber-reinforced resin sheet produced, it is possible to produce the laminate of the present invention.

### BRIEF DESCRIPTION OF DRAWINGS

FIG. 1 is a cross-sectional view illustrating one embodiment of the fiber-reinforced resin sheet of the present invention.

### DESCRIPTION OF EMBODIMENTS

The following definitions of terms are applied throughout this specification and of claims.

“Fiber-reinforced resin sheet” means a sheet material having a glass fiber cloth embedded in a matrix resin.

“Fluorinated resin” means a polymer compound (hereinafter, referred to as “a fluorinated polymer”) having fluorine atoms in its molecule, and also means a curable fluorinated copolymer or a cured product thereof.

“Solvent-soluble fluorinated resin” means a fluorinated resin which is soluble in some solvent to prepare a solution.

“Matrix resin” means a resin in which a glass fiber cloth is to be embedded, in a fiber-reinforced resin sheet.

“Glass fiber cloth” means a woven or nonwoven fabric made of glass fibers.

“Membrane structure building” means a building of which e.g. a roof or an exterior wall is totally or partly structured by a membrane material.

Units derived from a monomer in a polymer, are also referred to as monomer units. For example, units derived from olefin are also referred to as olefin units.

### [Fiber-Reinforced Resin Sheet]

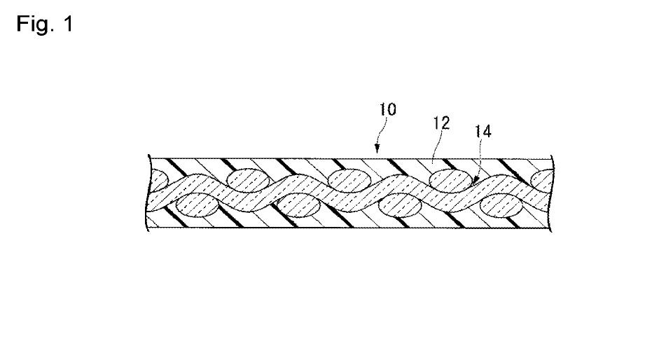

FIG. 1 is a cross-sectional view illustrating one embodiment of the fiber-reinforced resin sheet of the present invention. Fiber-reinforced resin sheet 10 has matrix resin 12 and glass fiber cloth 14 embedded in matrix resin 12

### (Matrix Resin)

A matrix resin contains at least 50 mass % of a fluorinated resin, and it may contain other resins or an additive as the case requires.

The proportion of the fluorinated resin is at least 50 mass %, preferably at least 60 mass %, particularly preferably at least 75 mass %, to the matrix resin (100 mass %). When the proportion of the fluorinated resin is at least the above lower limit value, the fiber-reinforced resin sheet is excellent in flame proofing property and weather resistance. The upper limit of the proportion of the fluorinated resin is 100 mass %.

### <Fluorinated Resin>

The fluorinated resin may, for example, be a fluoroolefin polymer, or a copolymer of a fluoroolefin and a monomer copolymerizable with the fluoroolefin. Here, the monomer (hereinafter, referred to as monomer (a)) copolymerizable with the fluoroolefin, means a monomer other than the fluoroolefin. The copolymer of the fluoroolefin and monomer (a) will be hereinafter referred to as copolymer (A).

The fluoroolefin may, for example, be vinyl fluoride, vinylidene fluoride, trifluoroethylene, chlorotrifluoroethylene, tetrafluoroethylene, pentafluoropropylene or hexafluoropropylene.

The fluoroolefin polymer may be a homopolymer of the fluoroolefin or a copolymer of at least two types of the fluoroolefins. Specifically, polyvinylidene fluoride (hereinafter, referred to as PVDF) or polyvinyl fluoride (hereinafter, referred to as PVF) may, for example, be mentioned.

The fluorinated resin in the matrix resin is preferably a solvent-soluble fluorinated resin or a cured product of a curable fluorinated copolymer soluble in an uncured state, in view of the after-mentioned process for producing a fiber-reinforced resin sheet.

In the case of a fluorinated resin such as PVDF or PVF soluble in a solvent, a glass fiber cloth is impregnated with a solution of the fluorinated resin, and a solvent is then removed, whereby a matrix resin is formed. The solvent-soluble fluorinated resin may be copolymer (A). Further, the matrix resin may be a blend resin of a solvent-soluble resin other than a fluorinated resin and a solvent-soluble fluorinated resin. For example, PVDF may be blended with an acryl resin. The acryl resin may, for example, be polymethyl methacrylate (hereinafter, referred to as PMMA).

The curable fluorinated copolymer is a copolymer categorized as copolymer (A). The curable fluorinated copolymer is a fluorinated copolymer soluble in a solvent and further having a reactive group. For example, a glass fiber cloth is impregnated with a solution containing a curable fluorinated copolymer having hydroxy groups as reactive groups and a curing agent having functional groups reactive with the hydroxy groups, a solvent is then removed, and thereafter, the curable fluorinated copolymer and the curing agent are reacted by e.g. heating to form a cured product of the curable fluorinated copolymer. This cured product is a fluorinated resin in the matrix resin.

Copolymer (A) is preferably the curable fluorinated copolymer, in view of excellent adhesion with a glass fiber cloth, and with a view to forming a matrix resin having high mechanical strength after being cured when used in combination with a curing agent. This curable fluorinated copolymer has fluoroolefin units, and units derived from a monomer having a reactive functional group as units derived from monomer (a). Further, such a curable fluorinated copolymer may further have units derived from a monomer (hereinafter, referred to as “monomer (a2)) which is neither a fluoroolefin nor the monomer having a reactive functional group. The reactive functional group may, for example, be a hydroxy group, a carboxy group or an amino group.

The curable fluorinated copolymer is preferably a hydroxy group-containing fluorinated copolymer having fluoroolefin units, units derived from a monomer (hereinafter, referred to as “monomer (a1)) having a hydroxy group and monomer (a2) units. It is preferred that the monomer (a2) units are capable of imparting properties (such as solvent solubility, transparency, glossiness, hardness, flexibility and pigment dispersibility) other than the curability, to a curable fluorinated polymer or a cured product thereof.

The curable fluorinated copolymer having hydroxy groups is preferably a copolymer obtainable by copolymerizing a fluoroolefin, monomer (a1) and monomer (a2).

The fluoroolefin for obtaining the curable fluorinated copolymer may be used alone or in combination of two or more of them. The fluoroolefin is preferably chlorotrifluoroethylene or tetrafluoroethylene.

Monomer (a1) may, for example, be an allyl alcohol, a hydroxyalkyl vinyl ether (such as 2-hydroxyethyl vinyl ether, 4-hydroxybutyl vinyl ether or cyclohexanediol monovinyl ether), a hydroxyalkyl allyl ether (such as 2-hydroxyethyl allyl ether), a vinyl hydroxyalkanoate (such as vinyl hydroxypropionate), an acrylic acid hydroxyalkyl ester (such as hydroxyethyl acrylate) or a methacryl acid hydroxyalkyl ester (such as hydroxyethyl methacrylate). Monomer (a1) having a hydroxy group may be used alone or in combination of two or more of them.

Monomer (a2) is preferably a vinyl monomer, that is a compound having a carbon-carbon double bond. The vinyl monomer, which is excellent in alternating copolymerizability with a fluoroolefin, can increase a polymerization yield. Further, even when it remains unreacted, influences on the matrix resin is little, and it can easily be removed in a production step.

The vinyl monomer may, for example, be a vinyl ether, an allyl ether, a carboxylic acid vinyl ester, a carboxylic acid allyl ester or an olefin, having no reactive functional groups.

The vinyl ether having no reactive functional groups may, for example, be a cycloalkyl vinyl ether (such as cyclohexyl vinyl ether) or an alkyl vinyl ether (such as nonyl vinyl ether, 2-ethylhexyl vinyl ether, hexyl vinyl ether, ethyl vinyl ether, n-butyl vinyl ether or t-butyl vinyl ether).

The allyl ether having no reactive functional groups may, for example, be an alkyl allyl ether (such as ethyl allyl ether or hexyl allyl ether).

The carboxylic acid vinyl ester having no reactive functional groups may, for example, be a vinyl ester of carboxylic acid (such as acetic acid, butyric acid, pivalic acid, benzoic acid or propionic acid). Further, as a carboxylic acid vinyl ester having a branched alkyl group, a commercially available Veova 9 or Veova 10 (tradename, manufactured by Shell Kagaku K.K.) may, for example, be used.

The carboxylic acid allyl ester having no reactive functional groups may, for example be an allyl ester of carboxylic acid (such as acetic acid, butyric acid, pivalic acid, benzoic acid or propionic acid).

The olefin may, for example, be ethylene, propylene or isobutylene.

Monomer (a2) is preferably one having a linear or branched alkyl group with at least three carbon atoms, in view of excellent flexibility of the matrix resin and good following property of the matrix resin to the glass fiber woven fabric at the time of deforming the fiber-reinforced resin sheet.

Monomer (a2) may be used alone or in combination of two or more of them.

The combination of monomers to constitute a curable fluorinated copolymer having hydroxy groups, is preferably the following combination (1), particularly preferably the following combination (2) or (3) among them, from the viewpoint of flame proofing property, weather resistance, adhesion and flexibility.

### Combination (1)

Fluoroolefin: tetrafluoroethylene or chlorotrifluoroethylene,

Monomer (a1): hydroxyalkyl vinyl ether,

Monomer (a2): at least one selected from cycloalkyl vinyl ether, alkyl vinyl ether and carboxylic acid vinyl ester.

### Combination (2)

Fluoroolefin: tetrafluoroethylene,

Monomer (a1): hydroxyalkyl vinyl ether,

Monomer (a2): t-butyl vinyl ether and carboxylic acid vinyl ester.

### Combination (3)

Fluoroolefin: chlorotrifluoroethylene,

Monomer (a1): hydroxyalkyl vinyl ether,

Monomer (a2): t-butyl vinyl ether and carboxylic acid vinyl ester.

The proportion of the fluoroolefin units in the curable fluorinated copolymer having hydroxy groups, is preferably from 30 to 70 mol %, particularly preferably from 40 to 60 mol %, in all the units (100 mol %) of the copolymer. When the proportion of the fluoroolefin units is at least the lower limit value, the fiber-reinforced resin sheet is more excellent in flame proofing property and weather resistance. When the proportion of the fluoroolefin units is at most the upper limit value, the matrix resin is excellent in adhesion to the glass fiber cloth.

The proportion of the monomer (a1) units is preferably from 0.5 to 20 mol %, particularly preferably from 1 to 15 mol %, in all the units (100 mol %) of the copolymer. When the proportion of monomer (a1) units is at least the lower limit value, the matrix resin is excellent in adhesion to the glass fiber cloth. When the proportion of monomer (a1) units is at most the upper limit value, the fiber-reinforced resin sheet is excellent in flexibility.

The proportion of the monomer (a2) units is preferably from 20 to 60 mol %, particularly preferably from 30 to 50 mol %, in all the units (100 mol %) of the copolymer. When the proportion of the monomer (a2) units is at least the lower limit value, the fiber-reinforced resin sheet is excellent in flexibility. When the proportion of the monomer (a2) units is at most the above upper limit value, the matrix resin is excellent in adhesion to the glass fiber cloth. Monomer (a2) is particularly preferably a monomer having a linear or branched alkyl group with at least three carbon atoms.

The number average molecular weight of the curable fluorinated copolymer is preferably from 3,000 to 50,000, particularly preferably from 5,000 to 30,000. When the number average molecular weight of the curable fluorinated copolymer is at least the lower limit value, the heat resistance is excellent. When the number average molecular weight of the curable fluorinated copolymer is at most the upper limit value, it is easily soluble in the solvent.

Commercial products of the curable fluorinated copolymer having hydroxy groups may, for example, be LUMIFLON (registered trademark) series (such as LF200, LF100 or LF710) (manufactured by Asahi Glass Company, Limited), ZEFFLE (registered trademark) GK series (such as GK-500, GK-510, GK-550, GK-570 or GK-580) (manufactured by Daikin Industries, Ltd.), FLUONATE (registered trademark) series (such as K-700, K-702, K-703, K-704, K-705 or K-707) (manufactured by DIC Corporation), or ETERFLON series (such as 4101, 41011, 4102, 41021, 4261A, 4262A, 42631, 4102A, 41041, 41111 or 4261A) (manufactured by Eternal Chemical Co., Ltd.)

The curable fluorinated copolymer is cured by a curing agent thereby to form a fluorinated resin as a matrix resin. The curing agent for the curable fluorinated copolymer having hydroxy groups may be an isocyanate type curing agent or a melamine type curing agent such as methylol melamine.

Copolymer (A) may be a fluoroolefin copolymer other than the above curable fluorinated copolymer. Such copolymer (A) may be a copolymer of a fluoroolefin and monomer (a) other than monomer (a1). This monomer (a) may be the above monomer (a2). Here, the monomers exemplified as the above monomer (a2) are a monomer suitable as a constituting unit for the curable fluorinated copolymer, and such monomers may be a monomer other than the above monomers, in copolymer (A) other than the above curable fluorinated copolymer. For example, a vinyl ether or a vinyl ester having a fluoroalkyl group, or a fluorinated cyclic monomer such as 2,2-bistrifluoromethyl-4,5-difluoro-1,3-dioxol, may be mentioned.

Copolymer (A) other than the curable fluorinated copolymer is preferably a solvent-soluble copolymer. Such a copolymer may be used as the above solvent-soluble fluorinated resin.

### <Other Resins>

The matrix resin may be a blend resin containing a resin other than the fluorinated resin.

Such other resins are preferably PMMA, polycarbonate, polyarylate, polycycloolefin, from the viewpoint of compatibility with the fluorinated resin and solvent-solubility.

The combination of the fluorinated resin and such other resins is preferably a combination of PVDF and PMMA, from the viewpoint of flame proofing property, weather resistance and solvent-solubility.

The proportion of such other resins in the blend resin is preferably at most 50 mass %, particularly preferably at most 40 mass %, in the blend resin (100 mass %), from the viewpoint of flame proofing property and weather resistance. In the case of the combination of PVDF and PMMA, the proportion of such other resins is preferably at least 10 mass %, particularly preferably at least 20 mass %, from the viewpoint of solvent-solubility. In the case other than the combination of PVDF and PMMA, the proportion of such other resins is more than 0 mass %.

### <Additives>

The matrix resin may contain a known additive, as the case requires. In a case where the matrix resin is a cured product of the curable fluorinated copolymer, it is preferred that an additive is blended to the curable fluorinated copolymer to carry out curing, thereby to form a cured product containing the additive.

The additive may, for example, be an ultraviolet absorber, a light stabilizer, an antioxidant, an infrared absorber, a flame retardant, a flame-retarding filler, an organic pigment, an inorganic pigment or a dye.

The matrix resin preferably contains an ultraviolet absorber with a view to allowing outdoor use for a further long term.

The proportion of the ultraviolet absorber is preferably from 0.5 to 20 parts by mass, particularly preferably from 1.0 to 10 parts by mass, per 100 parts by mass of the matrix resin.

The ultraviolet absorber may, for example, be an organic type ultraviolet absorber or an inorganic type ultraviolet absorber.

The organic type ultraviolet absorber, which is a compound having a Tr-conjugate molecular structure, is an organic compound exhibiting a ultraviolet shielding capacity by absorbing ultraviolet light and emitting it as secondary energy deformed.

The organic type ultraviolet absorber may, for example, be a benzotriazole type ultraviolet absorber, a benzophenone type ultraviolet absorber, a salicylate type ultraviolet absorber, a cyano acrylate type ultraviolet absorber, a nickel type ultraviolet absorber or a triazine type ultraviolet absorber.

The inorganic type ultraviolet absorber is mainly one having two types of performance of ultraviolet absorbing performance inherent in an inorganic compound and scattering performance (called Mie scattering or Rayleigh scattering) in an ultraviolet-ray wavelength region obtained by controlling a particle size.

The inorganic type ultraviolet absorber may, for example, be titanium oxide, zinc oxide, cerium oxide or iron oxide.

The light stabilizer may, for example, be a hindered amine type light stabilizer.

The antioxidant is classified into a chain stopper, a peroxide decomposing agent or a metal deactivator, according to the difference of action mechanism. The antioxidant may, for example, be a phenol type antioxidant, a phosphorine type antioxidant, a sulfurine type antioxidant or an amine type antioxidant.

The flame retardant may, for example, be a phosphorine type flame retardant or a bromine type flame retardant.

The flame-retarding filler may, for example, be aluminum hydroxide or magnesium hydroxide.

### (Glass Fiber Cloth)

The glass fiber cloth is a woven or nonwoven fabric made of glass fibers. The glass fiber cloth may be one which is preliminarily fixed by a binder between glass fibers.

### <Glass Fibers>

The glass fibers may, for example, be glass fibers made of alkali-free glass (E glass) having SiO₂, Al₂O₃ and CaO as main components, glass fibers made of low dielectric glass (D glass) having SiO₂ and B₂O₃ as main components, and glass fibers made of silica glass most of which is SiO₂ alone. The glass fibers made of silica glass are preferably glass fibers containing at least 80 mass % of SiO₂, more preferably glass fibers containing at least 90 mass % of SiO₂, particularly preferably glass fibers containing at least 93 mass % of SiO₂.

The difference (absolute value) between the refractive index of the glass fibers and the refractive index of the matrix resin is preferably at most 0.20 with a view to increasing total light transmittance, particularly preferably at most 0.10 with a view to reducing haze.

The refractive index is a refractive index to light with a wavelength of 589 nm, which is a numerical value measured in accordance with JIS Z8402-1.

### <Woven Fabric>

The woven fabric is preferably a woven fabric obtained by weaving yarn made of a plurality of glass single fibers, in view of flexibility and high strength of a woven fabric obtained.

A thickness of the glass single fibers is preferably from 0.018 to 1 Tex (g/1,000 m), particularly preferably from 0.07 to 0.46 Tex. When the thickness of the glass single fibers is at least the above lower limit value, the glass single fibers are hardly broken in production of a fiber-reinforced resin sheet. When the thickness of the glass single fibers is at most the above upper limit value, a woven fabric obtainable is excellent in flexibility and strength. The thickness of the glass single fibers is measured in accordance with JIS L0101.

The number of the glass single fibers constituting yarn is preferably from 5 to 1,000, particularly preferably from 10 to 300. When the number of the glass single fibers is at least the lower limit value, it is possible to facilitate handling in production of yarn. When the number of the glass single fibers is at most the upper limit value, it is possible to stably produce yarn.

The number (lengthwise and lateral) of the yarn twisted is preferably from 10 to 200 mesh (number/inch), particularly preferably from 20 to 150 mesh. When the number of the yarn twisted is at least the lower limit value, it is possible to increase the weaving speed in production of the woven fabric thereby to reduce a cost. When the number of the yarn twisted is at most the upper limit value, it is possible to obtain a woven fabric having a low open area ratio.

The weave of the woven fabric may, for example, be plane weaving, twill weaving, leno weaving or knitting.

The woven fabric may be one made of one type or at least two types of glass single fibers. Further, in the woven fabric, warps and wefts may have a different number of glass single fibers to constitute yarn.

### <Non-Woven Fabric>

The non-woven fabric is preferably one obtained by collecting a plurality of glass fibers and fixing a space between glass fibers by a binder, from the viewpoint of easiness of handling.

The basis weight of the non-woven fabric is preferably from 15 to 500 g/m², particularly preferably from 30 to 300 g/m². When the basis weight of the non-woven fabric is at least the lower limit value, the strength is excellent. When the basis weight of the non-woven fabric is at most the upper limit value, the matrix resin easily infiltrates into air gaps between glass fibers.

The thickness of the non-woven fabric is preferably from 80 to 600 μm, particularly preferably from 120 to 400 μm. When the thickness of the non-woven fabric is at least the lower limit value, the strength is excellent. When the thickness of the non-woven fabric is at most the upper limit value, the matrix resin can easily infiltrate into air gaps between the glass fibers.

The density of the non-woven fabric is preferably from 0.067 to 0.5 g/cm³, particularly preferably from 0.15 to 0.4 g/cm³. When the density of the non-woven fabric is at least the lower limit value, the strength is excellent. When the density of the non-woven fabric is at most the upper limit value, the matrix resin can easily infiltrate into air gaps between the glass fibers.

The binder may, for example, be polyvinyl alcohol, polyvinyl acetate, an acrylic resin, an epoxy resin, an unsaturated polyester resin or a melamine resin.

The non-woven fabric may be one made of one type or at least two types of glass fibers.

### <Open Area Ratio>

The open area ratio of the glass fiber cloth is at most 20%, preferably at most 15%, more preferably at most 12%, particularly preferably at most 9%. When the open area ratio of the glass fiber cloth is at most the upper limit value, the fiber-reinforced resin sheet is excellent in flame proofing property. The open area ratio of the glass fiber cloth is preferably at least 1%, more preferably at least 2%, particularly preferably at least 3% from the viewpoint that a solution of a solvent-soluble fluorinated resin or a solution of a curable fluorinated copolymer can easily infiltrate into air gaps between the glass fibers.

The open area ratio of the glass fiber cloth is determined from the following formula (1).

Open area ratio=(distance between glass fibers in the lengthwise direction of glass fiber cloth×distance between glass fibers in the lateral direction of glass fiber cloth)/(distance between centers of glass fibers in the lengthwise direction of glass fiber cloth×distance between centers of glass fibers in the lateral direction of glass fiber cloth)×100 (1)

The open area ratio can be adjusted by changing e.g. the thickness of the glass fibers and the number of the glass fibers twisted.

### (Fiber-Reinforced Resin Sheet)

The thickness (at an intersection point of glass fibers) of the fiber-reinforced resin sheet is preferably at most 1,000 μm, particularly preferably at most 400 μm, in view of e.g. excellent transparency and processability. The thickness of the fiber-reinforced resin sheet is preferably at least 24 μm, particularly preferably at least 50 μm, in view of e.g. excellent strength.

The total light transmittance of the fiber-reinforced resin sheet is at least 70%, preferably at least 80%, more preferably at least 83%, particularly preferably at least 86%.

The total light transmittance of the fiber-reinforced resin sheet is measured by illuminant D, in accordance with JIS K7361-1: 1997.

The total light transmittance of the fiber-reinforced resin sheet can be increased by reducing air gaps in the fiber-reinforced resin sheet. For example, according to the process for producing a fiber-reinforced resin sheet of the present invention as mentioned below, it is possible to reduce the air gaps in the fiber-reinforced resin sheet. Therefore, it is possible to suppress light scattering due to the difference in refractive indices between the glass fibers or the matrix resins and air in the air gaps, whereby the total light transmittance of the fiber-reinforced resin sheet can be at least 80%.

### (Operation and Effect)

The fiber-reinforced resin sheet of the present invention as described above, which has a matrix resin containing at least 50 mass % of a fluorinated resin and a glass fiber cloth having an open area ratio of at most 20% embedded in the matrix resin, has flame proofing property and excellent weather resistance. Further, the fiber-reinforced resin sheet is obtained by the after-mentioned production process of the present invention, therefore the air gaps in the fiber-reinforced resin sheet are reduced, the total light transmittance is at least 70%, and the transparency is excellent.

### [Process for Producing Fiber-Reinforced Resin Sheet]

Further, the present invention relates to a process for producing a fiber-reinforced resin sheet.

In a case where the matrix resin is a cured product of a curable fluorinated copolymer, a curable resin material containing a curable fluorinated copolymer is dissolved in a solvent to obtain a solution, the above glass fiber cloth is impregnated with the solution, removing the solvent, and then curing the above curable resin material to form the above matrix resin, whereby the fiber-reinforced resin sheet is produced.

In a case where the matrix resin is a solvent-soluble fluorinated resin, the matrix resin is dissolved in a solvent to obtain a solution, and then the glass fiber cloth is impregnated with the solution, followed by removing the solvent, whereby the fiber-reinforced resin sheet is produced.

Specifically, a production process having the following steps (I) to (III) is preferred in a case where the matrix resin is a cured product of a curable fluorinated copolymer, and a production process having the following steps (I) and (II) is preferred in a case where the matrix resin is a solvent-soluble fluorinated resin.

Here, the following “resin material” means a solvent-soluble fluorinated resin itself as a matrix resin or one which is formed into a matrix resin by e.g. curing. A curable resin material containing a curable fluorinated copolymer means a material containing at least a component for curing the curable fluorinated copolymer, such as a curing agent, and a curable fluorinated copolymer. The resin material may also contain e.g. the above additives.

As the process for producing a fiber-reinforced resin sheet of the present invention, a production process having the following steps (I) to (III) is preferred in a case where the matrix resin is a cured product of a curable fluorinated copolymer, and a production process having the following steps (I) and (II) is preferred in a case where the matrix resin is a solvent-soluble fluorinated resin.

(I) A step of impregnating a glass fiber cloth with a solution having a resin material for constituting a matrix resin dissolved in a solvent.

(II) A step of removing the solvent after the above step (I) thereby to form a resin material containing no solvent (in a case where the resin material is a solvent-soluble fluorinated resin, a matrix resin is formed).

(III) A step of forming a matrix resin by curing the resin material at the same time with the above step (II) or after the above step (II), in the case of a resin material containing a curable fluorinated copolymer.

### (Step (I))

The resin material may, for example, a solvent-soluble fluorinated resin for matrix resin, a combination of a curable fluorinated copolymer and a curing agent, or a combination of them with other resins, as mentioned above.

The solvent may, for example, be toluene, xylene, butyl acetate, methyl ethyl ketone or methylene chloride. The proportion of the resin material in the solution (100 mass %) is preferably from 30 to 85 mass %, particularly preferably from 40 to 75 mass %.

The solution may contain the following additives for adjusting the properties of the solution, other than the above-mentioned additives for the matrix resin.

A surface adjustor, an emulsifier, a film-forming assistant (high boiling point organic solvent), a thickener, a preservative, a silane coupling agent, an anti-foaming agent and the like.

The method for impregnating a glass fiber cloth with a solution may, for example, be a method having the following operations 1 to 5.

Operation 1: A glass fiber cloth is provided on an underlying film.

Operation 2: A prescribed amount of a solution of a resin material is supplied to the glass fiber cloth.

Operation 3: A covering film is placed on the glass fiber cloth impregnated with the above solution.

Operation 4: A hand roller is reciprocated on the covering film to remove bubbles from the glass fiber cloth impregnated with the solvent.

Operation 5: The covering film is peeled and sent to the step (II).

### (Step (II))

The removal of the solvent is usually carried out by heating.

The heating temperature may be at least a temperature at which the solvent evaporates, and lower than a temperature at which a resin material and additives are decomposed, or lower than a temperature at which an underlying film deforms.

The heating time may be a time at which a solvent is completely evaporated and removed.

When the resin material is not curable, a fiber-reinforced resin sheet may be obtained by this step (II). When the resin material is a curable resin material such as a combination of a curable fluorinated copolymer and a curing agent, the resin material is cured in the following step (III).

### (Step (III))

Curing of the resin material is usually carried out by heating.

When the resin material is a curable resin material such as the combination of a curable fluorinated copolymer and a curing agent, the step (III) is carried out subsequent to the step (II). The step (III) and the step (II) may be a continuous step. For example, even after the solvent is removed by the heating in the step (II), the heating may be continued so as to cure a curable resin material. After the solvent is evaporated, the heating temperature may be increased to carry out the curing. Or the heating temperature during removing the solvent may be gradually increased so as to carry out curing while continuously increasing the temperature after the solvent is removed.

The heating temperature may, for example, be at least a temperature at which the curing agent is reacted with hydroxy groups in the curable fluorinated copolymer, and lower than the temperature at which a resin material and additives are decomposed, or lower than the temperature at which an underlying film is deformed.

The heating time may properly be set depending on the extent of curing of the resin material.

### (Operation and Effect)

According to the process for producing a fiber-reinforced resin sheet of the present invention as mentioned above, the resin material can easily infiltrate into air gaps between the glass fibers since the glass fiber cloth is impregnated with the solution having the resin material dissolved in the solvent. As a result, it is possible to reduce air gaps in the fiber-reinforced resin sheet obtainable, and therefore it is possible to suppress light scattering due to the difference of indices between the glass fibers or the matrix resin and air in the air gaps, whereby the total light transmittance of the fiber-reinforced resin sheet can be at least 70%.

### (Laminate)

Further, the present invention relates to a laminate having a layer of the above fiber-reinforced resin sheet and a layer of a second fluorinated resin provided on one side or each side of the fiber-reinforced resin sheet, said laminate having a total light transmittance of at least 70%. The total light transmittance of the laminate is preferably at least 80%.

The laminate of the present invention has flame proofing property and is excellent in weather resistance and transparency, like the above fiber-reinforced resin sheet.

The second fluorinated resin may be the same type as the fluorinated resin (hereinafter, also referred to as a first fluorinated resin) in the above matrix resin, or a different type from the first fluorinated resin. The same type of the fluorinated resin means a fluorinated resin to be used as the above matrix resin, which is mentioned as the above first fluorinated resin. The different type of the fluorinated resin means a fluorinated resin which cannot substantially be used as the above first fluorinated resin, that is a curable fluorinated copolymer or a fluorinated copolymer substantially insoluble in a solvent.

In a case where the second fluorinated resin is the same type as the first fluorinated resin, the second fluorinated resin may be the same as or different from the first fluorinated resin, in the laminate. In the laminate, a case where the second fluorinated resin is different from the first fluorinated resin may, for example, be a case where the first fluorinated resin is a cured product of a hydroxy group-containing fluorinated copolymer and the second fluorinated resin is a thermoplastic fluorinated resin.

The second fluorinated resin is preferably a thermoplastic fluorinated resin. The thermoplastic fluorinated resin may, for example, be a homopolymer of a fluoroolefin, a copolymer of at least two types of fluoroolefins, a copolymer of a fluoroolefin and another fluorinated monomer such as a perfluoroalkyl vinyl ether, or a copolymer of a fluoroolefin and an olefin.

The thermoplastic fluorinated resin may be a fluorinated resin substantially insoluble in a solvent.

Since the thermoplastic fluorinated resin can be subjected to melt-molding such as extrusion molding or injection molding, the resulting molded product may be used for forming a layer of the laminate of the present invention. It is preferred that a film or sheet obtained especially by extrusion molding is used for producing the laminate of the present invention.

The thickness of a film or sheet of the second fluorinated resin is preferably from 25 to 300 μm, particularly preferably from 50 to 200 μm, in view of an ultraviolet shielding effect and strength at the time of heat bonding.

A specific thermoplastic fluorinated resin may, for example, be ETFE, a tetrafluoroethylene/perfluoro(alkyl vinyl ether) copolymer [PFA], a tetrafluoroethylene/perfluoro(methyl vinyl ether)/perfluoro(propyl vinyl ether) copolymer [MFA], a tetrafluoroethylene/hexafluoropropylene copolymer [FEP], PVDF, PVF, a tetrafluoroethylene/hexafluoropropylene/vinylidene fluoride copolymer [THV], polychlorotrifluoroethylene [PCTFE], an ethylene/chlorotrifluoroethylene copolymer [ECTFE] or a tetrafluoroethylene/2,2-bistrifluoromethyl-4,5-difluoro-1,3-dioxol copolymer.

A layer of the second fluorinated resin may also contain e.g. a resin other than a fluorinated resin, or an additive, as the case requires. The layer of the second fluorinated resin preferably contains an ultraviolet absorber as the additive in view of weather resistance of the fiber-reinforced resin sheet.

Examples and preferred types of the ultraviolet absorber in the layer of the second fluorinated resin is the same with the above ultraviolet absorber which may be contained in the matrix resin. Further, the proportion of the ultraviolet absorber is preferably from 0.1 to 20 parts by mass, particularly preferably from 0.2 to 10 parts by mass, per 100 parts by mass of the second fluorinated resin.

The layer of the fiber-reinforced resin sheet and the layer of the second fluorinated resin may be bonded directly by e.g. fusion, or they may be bonded via an adhesive layer. In a case where the second fluorinated resin is e.g. a cured product of a curable fluorinated copolymer, the curable fluorinated copolymer may be cured on the surface of the fiber-reinforced resin sheet, whereby it is possible to form the layer of the second fluorinated resin bonded directly on the fiber-reinforced resin sheet.

In a case where the layer of the second fluorinated resin is formed by laminating a film or sheet of the thermoplastic fluorinated resin as mentioned below, it is preferred to adhere e.g. the film to the fiber-reinforced resin sheet by using an adhesive. The adhesive is preferably a curing adhesive or a hot melt adhesive. A specific adhesive may, for example, be a polyester adhesive, an epoxy adhesive, an acrylate adhesive or an urethane adhesive.

The laminate may, for example, be the following.

ETFE layer (containing ultraviolet absorber)/adhesive layer/fiber-reinforced resin sheet layer/adhesive layer/ETFE layer (containing ultraviolet absorber).

ETFE layer (containing ultraviolet absorber)/adhesive layer (containing ultraviolet absorber)/fiber-reinforced resin sheet layer/adhesive layer (containing ultraviolet absorber)/ETFE layer (containing ultraviolet absorber).

ETFE layer (containing ultraviolet absorber)/adhesive layer (containing ultraviolet absorber)/fiber-reinforced resin sheet layer/adhesive layer/ETFE layer (containing ultraviolet absorber).

ETFE layer (containing ultraviolet absorber)/adhesive layer/fiber-reinforced resin sheet layer/ETFE layer (containing ultraviolet absorber).

ETFE layer (containing ultraviolet absorber)/fiber-reinforced resin sheet layer/ETFE layer (containing ultraviolet absorber).

Fiber-reinforced resin sheet layer/adhesive layer/ETFE layer (containing ultraviolet absorber).

Fiber-reinforced resin sheet layer/adhesive layer (containing ultraviolet absorber)/ETFE layer (containing ultraviolet absorber).

Fiber-reinforced resin sheet layer/ETFE layer (containing ultraviolet absorber).

A process for producing a laminate is preferably a method of thermal compression of the fiber-reinforced resin sheet and a film or sheet of the second fluorinated resin, or a method of adhering the fiber-reinforced resin sheet and a film or sheet of the second fluorinated resin by using an adhesive. In the case of using e.g. a curing adhesive or a hot melt adhesive as the adhesive, preferred is a method of forming an adhesive layer on the surface of the fiber-reinforced resin sheet and laminating a film or sheet of the second fluorinated resin to carry out thermal compression, or a method of forming an adhesive layer on one side of a film or sheet of the second fluorinated resin, and then laminating the fiber-reinforced resin sheet to carry out thermal compression.

In addition, a method of applying a solution or dispersion of the second fluorinated resin on the surface of the fiber-reinforced resin sheet, and removing a solvent to solidify the second fluorinated resin, or a method of forming a layer of the second fluorinated resin by applying a solution of the curable polymer on the surface of the fiber-reinforced resin sheet, removing a solvent, and curing the curable polymer by e.g. heating.

### EXAMPLES

Now, the present invention will be described in further detail with reference to Examples, but it should be understood that the present invention is by no means restricted thereto.

Ex. 1 and 5 to 8 are Examples of the present invention, and Ex. 2 to 4 are Comparative Examples.

### [Evaluation Method]

### (Total Light Transmittance and Haze)

Using a haze meter (NDH5000, manufactured by Nippon Denshoku Industries Co., Ltd.), the total light transmittance and the haze of a fiber-reinforced resin sheet were measured by a D light source, in accordance with JIS K7361-1: 1997.

### (Accelerated Weather Resistance Test)

Using an accelerated weather resistance tester (Eye Super UV Tester, manufactured by Suga Test Instruments Co., Ltd.), an accelerated weather resistance test was carried out. The total light transmittance and the haze of a fiber-reinforced resin sheet after exposure for 225 hours were measured.

### (Flame Proofing Property Evaluation 1)

A test specimen (30 cm×30 cm) of a fiber-reinforced resin sheet was fixed so that the surface of the test specimen would be inclined at 45° to a horizontal direction. the test specimen was exposed to flame (length: 2.5 cm) of a spirit lamp from the bottom of the test specimen, and the time until the test specimen ignited was measured to carry out evaluation based on the following standards.

◯ (Good): Time until ignition was at least 30 seconds.

Δ (Permissible): Time until ignition was at least 10 seconds and less than 30 seconds.

x (Bad): Time until ignition was less than 10 seconds.

### (Flame Proofing Property Evaluation 2)

A test specimen (30 cm×30 cm) of a fiber-reinforced resin sheet was fixed so that the surface of the test specimen would be horizontal. A cotton was disposed below the test specimen. After igniting a timber (2 cm×2 cm×2 cm), the timber was placed on the test specimen, and the time until the cotton ignited was measured to carry out evaluate based on the following standards.

◯ (Good): Time until ignition was at least 5 minutes.

Δ (Permissible): Time until ignition was at least 1 minute and less than 5 minutes.

x (Bad): Time until ignition was less than 1 minute.

### Ex. 1

A glass fiber woven fabric (using a glass fiber made of E glass, refractive index of glass: 1.55, thickness of glass single fiber: 0.162 Tex, number of glass single fibers constituting yarn: 130, number of yarns twisted (lengthwise direction and lateral direction): 60 mesh, basis weight of woven fabric: 100 g/m², thickness of woven fabric at an intersection point of yarn: 93 μm, open area ratio of woven fabric: 3%, total light transmittance of woven fabric: 50%) obtained by plain-weaving glass fiber yarn, was prepared.

To a xylene solution (solid content: 60 mass %) of a fluoroolefin/vinyl ether copolymer (LUMIFLON (registered trademark) LF200, manufactured by Asahi Glass Company, Limited, this hydroxy group-containing copolymer will be hereinafter referred to as “LF200”), 48.2 parts by mass of hexamethylene diisocyanate (Duranate (registered trademark) E402-90T, manufactured by Asahi Kasei Chemicals Corporation) and 2 parts by mass of a benzophenone type ultraviolet absorber (CYASORBUV531, manufactured by CYTEC Industries Inc.) per 100 parts by mass of LF200, were added to prepare a resin solution.

The above glass fiber woven fabric was spread on a polyethylene terephthalate (hereinafter, referred to as “PET”) film with a thickness of 50 μm. The resin solution was supplied to the center of the glass fiber woven fabric, and the PET film with a thickness of 50 μm was placed on the glass fiber woven fabric. A hand roller was reciprocated on the PET film to remove bubbles from the glass fiber woven fabric impregnated with the resin solution.

The PET film placed on the glass fiber woven fabric was peeled off, and the glass fiber cloth impregnated with the resin solution was put in a hot air constant temperature oven. The hot air constant temperature oven was heated at 80° C. for one hour to remove a solvent, and at the same time, LF200 was cured by hexamethylene diisocyanate to produce a fiber-reinforced resin sheet. In Ex. 1, a step of each of impregnation and drying was carried out once. The thickness (at an intersection point of glass fibers) of the fiber-reinforced resin sheet was 136 μm. The evaluation result of the fiber-reinforced resin sheet is shown in Table 1.

### Ex. 2

A tetrahydrofuran solution (solid content: 20 mass %) of PVC (TH-640, manufactured by Taiyo Vinyl Corporation) was prepared.

In the same manner as in Example 1, a glass fiber woven fabric was impregnated with a PVC solution, followed by drying. In order to secure a thickness of the matrix resin, the same step was carried out three times in total to produce a fiber-reinforced resin sheet. The thickness (at an intersection point of glass fibers) of the fiber-reinforced resin sheet was 143 μm. The evaluation result of the fiber-reinforced resin sheet is shown in Table 1.

### Ex. 3

A dispersion (Fluon (registered trademark) PTFE AD912L, manufactured by Asahi Glass Company, Limited, PTFE concentration: 50 mass %, containing a nonionic stabilizer) of PTFE was prepared.

In the same manner as in Example 1, a glass fiber woven fabric was impregnated with the dispersion of PTFE, followed by sintering at 380° C. for five minutes. The same step was carried out twice in total to produce a fiber-reinforced resin sheet. The thickness (at an intersection point of glass fibers) of the fiber-reinforced resin sheet was 130 μm. The evaluation result of the fiber-reinforced resin sheet is shown in Table 1.

### Ex. 4

A fiber-reinforced resin sheet was produced in the same manner as in Example 1 except that the glass fiber woven fabric was changed to one having an open area ratio of 30%. The thickness (at an intersection point of glass fibers) of the fiber-reinforced resin sheet was 152 μm. The evaluation result of the fiber-reinforced resin sheet is shown in Table 1.

### Ex. 5

A fiber-reinforced resin sheet was produced in the same manner as in Example 1 except that LF200 was changed to a mixture of PVDF and PMMA (an N-methylpyrrolidone solution (solid content concentration: 38 mass %) having PVDF manufactured by Arkemas and PMMA manufactured by Kuraray Co., Ltd. mixed in a ratio of PVDF:PMMA=60:40 (mass ratio)). The thickness (at an intersection point of glass fibers) of the fiber-reinforced resin sheet was 128 μm. The evaluation result of the fiber-reinforced resin sheet is shown in Table 1.

### Ex. 6

A 100 μm-thick ETFE film containing 0.5 mass % of cerium oxide as an ultraviolet absorber was laminated on at least one side of the fiber-reinforced sheet in Ex. 1 via an adhesive layer (product No. BLS-PC27, manufactured by Toyo Ink Manufacturing Co., Ltd., 8 μm in dry thickness) to obtain a laminate. The thickness (at an intersection point of glass fibers) of the laminate was 242 μm. The evaluation result of the laminate is shown in Table 2. Further, the weather resistance test was carried out so that the laminate surface of ETFE faced an UV lamp of the tester.

### Ex. 7

The ETFE film containing an ultraviolet absorber, prepared in Ex. 6, was laminated on each side of the fiber-reinforced sheet described in Ex. 1, via the same adhesive layer as in Example 6 to obtain a laminate. The thickness (at an intersection point of glass fibers) of the laminate was 352 μm. The evaluation result of the laminate is shown in Table 2.

### Ex. 8

An woven fabric (refractive index of glass: 1.45, thickness of glass single fiber: 0.148 Tex, number of glass single fibers constituting yarn: 150, number of yarns twisted (length and width): 60 mesh, basis weight of woven fabric: 105 g/m², thickness of woven fabric at an intersection point of yarn: 99 μm, open area ratio of woven fabric: 2%, total light transmittance of woven fabric: 48%) of glass fibers made of high silica glass containing 96 mass % of SiO₂, was prepared. The fiber-reinforced resin sheet was produced in the same manner as in Example 1 except that the glass fiber woven fabric was used. The thickness (at an intersection point of glass fibers) of the fiber-reinforced resin sheet was 144 μm. The evaluation result of the fiber-reinforced resin sheet is shown in Table 1.

TABLE 1

| Ex. | | 1 | 2 | 3 | 4 | 5 | 8 |
|---|---|---|---|---|---|---|---|
| Matrix resin | | Cured | PVC | PTFE | Cured | PVDF + | Cured |
| | | product | | | product | PMMA | product |
| | | of LF200 | | | of LF200 | | of LF200 |
| Open area ratio of | | 3 | 3 | 3 | 30 | 3 | 2 |
| glass fiber cloth (%) | | | | | | | |
| Before accelerated | Total light | 89 | 91 | 32.6 | 91 | 85 | 90 |
| weather resistance | transmittance | | | | | | |
| test | (%) | | | | | | |
| | Haze (%) | 94 | 33 | — | 81 | 98 | 8 |
| After accelerated | Total light | 88 | 65 | 34.5 | 90 | 85 | 88 |
| weather resistance | transmittance | | | | | | |
| test | (%) | | | | | | |
| | Haze (%) | 95 | 42 | — | 80 | 97 | 10 |

| | | | | | | |
|---|---|---|---|---|---|---|
| Flame proofing property evaluation 1 | ◯ | X | — | ◯ | ◯ | ◯ |
| Flame proofing property evaluation 2 | ◯ | X to Δ | — | X | ◯ | ◯ |

TABLE 2

| Ex. | | 6 | 7 |
|---|---|---|---|
| Matrix resin | | Cured product | Cured product |
| | | of LF200 | of LF200 |
| Open area ratio of | | 3 | 3 |
| glass fiber cloth (%) | | | |
| Laminate structure | | ETFE layer/ | ETFE layer/ |
| | | adhesive layer/ | adhesive layer/ |
| | | fiber-reinforced | fiber-reinforced |
| | | resin sheet | resin sheet in |
| | | in Ex. 1 | Ex. 1/adhesive |
| | | | layer/ETFE layer |
| Before accelerated | Total light | 86 | 84 |
| weather resistance | transmittance | | |
| test | (%) | | |
| | Haze (%) | 96 | 97 |
| After accelerated | Total light | 86 | 84 |
| weather resistance | transmittance | | |
| test | (%) | | |
| | Haze (%) | 95 | 96 |

| | | |
|---|---|---|
| Flame proofing property evaluation 1 | ◯ | ◯ |
| Flame proofing property evaluation 2 | ◯ | ◯ |

The fiber-reinforced resin sheet in each of Ex. 1, 5 and 8, and the laminate in each of Ex. 6 and 7, were excellent in total light transmittance, weather resistance and flame proofing property.

The fiber-reinforced resin sheet in Ex. 2, of which matrix resin was PVC, was insufficient in weather resistance and flame proofing property. The fiber-reinforced resin sheet in Ex. 3, of which matrix resin was a sintered product of a PTFE dispersion, was low in total light transmittance. The fiber-reinforced resin sheet in Ex. 4, of which glass fiber woven fabric had a high open area ratio, was insufficient in flame proofing property.

The laminate in each of Ex. 6 and 7 has an ETFE film at one side or both sides of the laminate, whereby the fiber-reinforced resin sheet is protected by the ETFE film.

### INDUSTRIAL APPLICABILITY

The fiber-reinforced resin sheet of the present invention and the laminate of the present invention, which has flame proofing property and excellent weather resistance and transparency, are suitable as a membrane material (such as a roof material, a ceiling material, an exterior wall material or an interior wall material) for membrane structure buildings (such as sports facilities, large-scale green houses and atria) or a covering material for agricultural green houses. Further, at the time of bonding the fiber-reinforced resin sheet or the laminate of the present invention with other members by means of heat sealing, a conventional apparatus for heat sealing may be used under conventional conditions.

The fiber-reinforced resin sheet of the present invention and the laminate of the present invention, may be used for various applications not only for membrane materials for membrane structure buildings or covering materials for agricultural green houses, but also for materials made of a fiber-reinforced resin. As other applications, the fiber-reinforced resin sheet and the laminate are useful for e.g. an outdoor use plate material (such as a sound-proof wall, a wind break fence, a wave barrier fence, a canopy for garages, a shopping mall, a wall for walking passage or a ceiling material), an anti-shattering film for glass, a heat resistance/water resistance sheet, a building material (such as a tent material for tent warehouses, a membrane material for sunshades, a partial roof material for skylight, an window material alternative to glass, a partition membrane material for flame proofing property, a curtain, an exterior wall reinforcing material, an water proof membrane, a smoke proof membrane, a non-combustible transparent partition, a road reinforcing material, an interior (such as lighting, an wall surface, a blind) or an exterior (such as a tent or a sign board)), life leisure goods (such as a fishing rod, a racket, a golf club and a screen), a material for automobiles (such as a hood, a dumping material or a body), a material for airplanes, a material for ships, an exterior material for home electric appliances, a tank, a container interior wall, a filter, a membrane material for construction work, an electronic material (such as a printed board material, a wiring board material, an insulation film or a release film), a surface material for a solar cell module, a mirror protection material for solar thermal power generation or a solar water heater.

This application is a continuation of PCT Application No. PCT/JP2014/069246, filed on Jul. 18, 2014, which is based upon and claims the benefit of priority from Japanese Patent Application No. 2013-155801 filed on Jul. 26, 2013 and Japanese Patent Application No. 2013-267914 filed on Dec. 25, 2013. The contents of those applications are incorporated herein by reference in their entirety.

### REFERENCE SYMBOLS

10: Fiber-reinforced resin sheet
12: Matrix resin
14: Glass fiber cloth

What is claimed is:

1. A fiber-reinforced resin sheet, comprising:
a matrix resin containing at least 50 mass % of a fluorinated resin; and
a glass fiber cloth having an open area ratio of at most 20%, embedded in the matrix resin,
said fiber-reinforced resin sheet having a total light transmittance of at least 70%.

2. The fiber-reinforced resin sheet according to claim 1, wherein the total light transmittance is at least 80%.

3. The fiber-reinforced resin sheet according to claim 1, wherein the matrix resin consists of the fluorinated resin.

4. The fiber-reinforced resin sheet according to claim 1, wherein the fluorinated resin is a cured product of a curable fluorinated copolymer having units derived from a fluoroolefin and units derived from a monomer other than the fluoroolefin, said monomer being copolymerizable with the fluoroolefin.

5. The fiber-reinforced resin sheet according to claim 4, wherein the units derived from a monomer other than the fluoroolefin are units derived from a monomer having a hydroxy group.

6. The fiber-reinforced resin sheet according to claim 1, wherein the matrix resin contains a solvent-soluble fluorinated resin.

7. The fiber-reinforced resin sheet according to claim 6, wherein the matrix resin is a blend resin containing polyvinylidene fluoride and polymethyl methacrylate.

8. The fiber-reinforced resin sheet according to claim 1, wherein the matrix resin further contains an ultraviolet absorber.

9. The fiber-reinforced resin sheet according to claim 1, which is a membrane material for membrane structure buildings.

10. A process for producing the fiber-reinforced resin sheet as defined in claim 4, which comprises:
impregnating the glass fiber cloth with a solution having a curable resin material containing the curable fluorinated copolymer dissolved in a solvent,
removing the solvent, and then
curing the curable resin material to form the matrix resin.

11. A process for producing the fiber-reinforced resin sheet as defined in claim 6, which comprises:
impregnating the glass fiber cloth with a solution having the matrix resin dissolved in a solvent, and then
removing the solvent.

12. A laminate, comprising:
of the fiber-reinforced resin sheet as defined in claim 1; and
a layer of a second fluorinated resin provided on one side or each side of the fiber-reinforced resin sheet,
said laminate having a total light transmittance of at least 70%.

13. The laminate according to claim 12, wherein the layer of a second fluorinated resin is a layer formed from a film or sheet of the second fluorinated resin.

14. The laminate according to claim 12, wherein the layer of a second fluorinated resin contains an ultraviolet absorber.

15. The laminate according to claim 12, which is a membrane material for membrane structure buildings.
